(19) United States
(12) Patent Application Publication
(10) Pub. No.: US 2010/0162575 A1
(43) Pub. Date: Jul. 1, 2010

(54) GARDENING SHEARS CAPABLE OF INCREASING SHEARING AREA

(76) Inventor: Thomas Lin, Taichung County (TW)

Correspondence Address: BROWDY AND NEIMARK, P.L.L.C.;624 NINTH STREET, NW, SUITE 300, WASHINGTON, DC, 20001-5303, US

(21) Appl. No.: 12/409,807

(22) Filed: Mar. 24, 2009

(30) Foreign Application Priority Data
Dec. 31, 2008 (CN) 200820183923.5

(51) Int. Cl. B26B 13/00

(52) U.S. Cl. 30/245

(57) ABSTRACT

A pair of gardening shears include two handles each having two teeth portions, and two cutting blades pivotally connected to each other and each having a teeth portion. The teeth portions of one of the handles are respectively engaged with one of the teeth portions of the other one of the handles and the teeth portion of one of the cutting blades. Accordingly, the gardening shears of the present invention can be used to cut branches that have a large cross-sectional area by means of the engaged teeth.

### BACKGROUND OF THE INVENTION

1. Field of the Invention

The present invention relates generally to a gardening implement, and more specifically to gardening shears that can increase shearing area by means of teeth meshing transmission.

2. Description of the Related Art

FIG. 1 shows a pair of conventional gardening shears 10, comprising two handles 12, and two cutting blades 14 pivotally connected to each other and fixed to the handles 12 respectively. When the handles 12 are forced to move toward each other, the cutting blades 14 can be driven to cut branches.

Because the conventional gardening shears 10 are constructed with a single pivot, the cutting angle between the cutting blades 14 is determined by the opening angle between the handles 12. However, the handles 12 has always a fixed opening angle to cause the restriction of the cutting angle between the cutting blades 14, and thus the conventional gardening shears 10 can only be used to cut a branch that has a small diameter. As described above, it can be seen that the conventional gardening shears 10 are inconvenient in operation.

### SUMMARY OF THE INVENTION

The present invention has been accomplished in view of the above-noted circumstances. It is one objective of the present invention to provide a pair of gardening shears, which have a large shearing area to cut a branch with a large cross-sectional area.

To achieve this objective of the present invention, the gardening shears comprise a first handle having a first teeth portion and a second teeth portion, a second handle having a third teeth portion and a forth teeth portion engaged with the second teeth portion of the first handle, a first cutting blade connected to the first handle and the second handle and provided with a fifth teeth portion engaged with the first teeth portion of the first handle, and a second cutting blade pivotally connected to the first cutting blade and connected to the first handle and the second handle, and provided with a sixth teeth portion engaged with the third teeth portion of the second handle.

When the first handle and the second handle are forced to move away from each other, the first cutting blade and the second cutting blade can be driven to move away from each other for increasing a shearing area defined between the first cutting blade and the second cutting blade through the engagement of the first teeth portion and the fifth teeth portion and the engagement of the third teeth portion and the sixth teeth portion.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a front view of gardening shears according to a prior art;

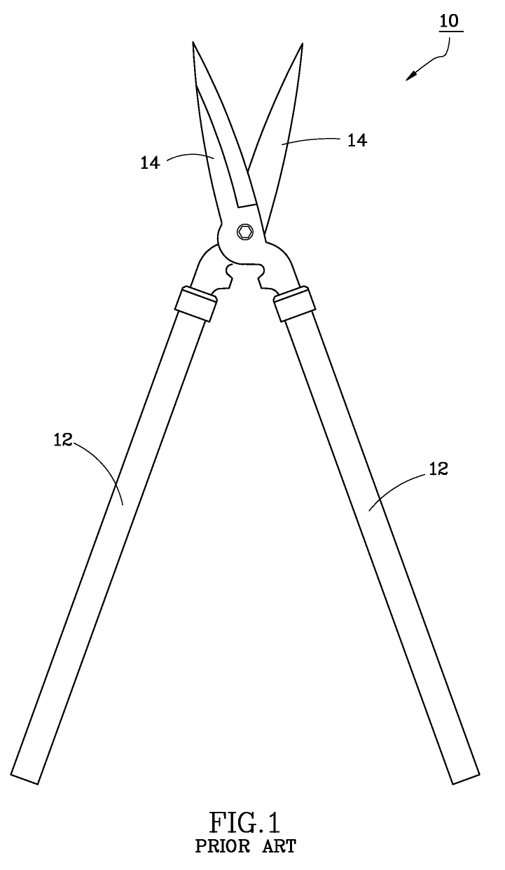

FIG. 2 is an exploded view of a pair of gardening shears according to a first preferred embodiment of the prevent invention;

FIG. 3 is a front view of the gardening shears according to the first preferred embodiment of the prevent invention, in which two protecting covers are removed for illustrative purpose;

FIG. 4 is another front view of the gardening shears according to the first preferred embodiment of the present invention, showing the operation status of the gardening shears;

FIG. 5 is an exploded view of a pair of gardening shears according to a second preferred embodiment of the prevent invention, and

FIG. 6 is a front view of the gardening shears according to the second preferred embodiment of the prevent invention, in which two protecting covers are removed for illustrative purpose.

### DETAILED DESCRIPTION OF THE INVENTION

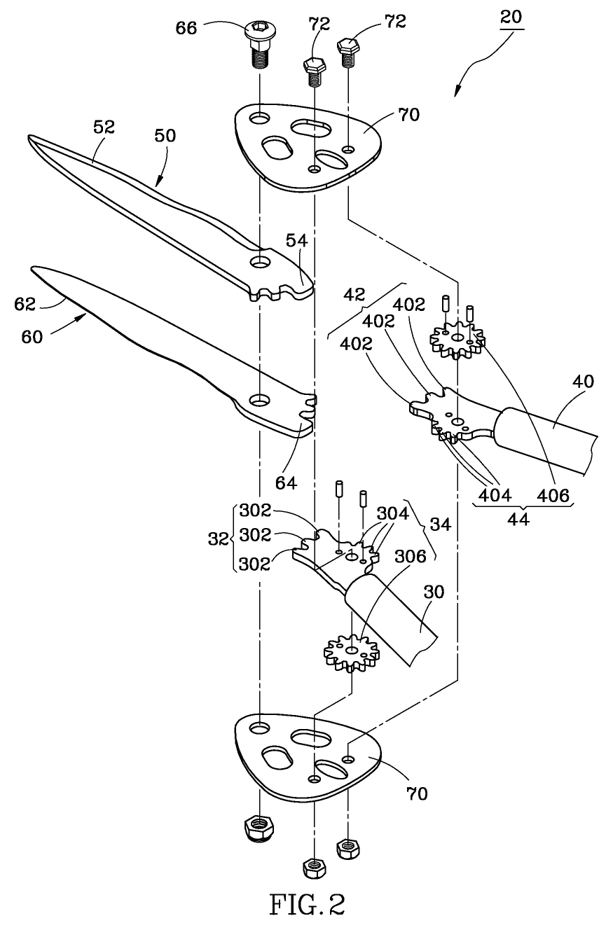

As shown in FIG. 2, a pair of gardening shears 20 in accordance with a first preferred embodiment of the present invention comprises a first handle 30, a second handle 40, a first cutting blade 50, a second cutting blade 60, and a pair of protecting covers 70.

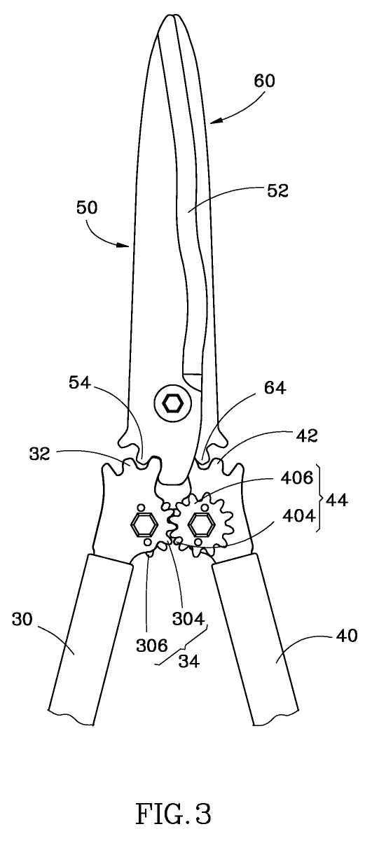

As shown in FIGS. 2 and 3, the first handle 30 is provided at a top end thereof with a first teeth portion 32 and a second teeth portion 34. The first teeth portion 32 is formed with a plurality of first top teeth 302 that are integrally formed at the top end of the first handle 30, and the second teeth portion 34 is formed with a plurality of first lateral teeth 304 and teeth of a first gear 306 located behind the lateral teeth 304.

The second handle 40 is provided at a top end thereof with a third teeth portion 42 and a forth teeth portion 44. The third teeth portion 42 is formed with a plurality of second top teeth 402 that are integrally formed at the top end of the second handle 40, and the forth teeth portion 44 is formed with a plurality of second lateral teeth 404 engaged with the first gear 306 and teeth of a second gear 406 engaged with the first lateral teeth 304.

The first cutting blade 50 has a first cutting edge 52 and a fifth teeth portion 54 integrally formed at a bottom end of the first cutting blade 50 and engaged with the first teeth portion 32 of the first handle 30.

The second cutting blade 60 is pivotally connected to the first cutting blade 50 through a pivot 66 and provided with a second cutting edge 62 facing the first cutting edge 52, and a sixth teeth portion 64 integrally formed at a bottom end of the second cutting blade 60 and engaged with the third teeth portion 42 of the second handle 40.

The protecting covers 70 each have a top pivotally connected to the pivot 66 and a bottom fastened to the first handle 30 and the second handle 40 through two screws 72 to clamp the first handle 30, the second handle 40, the first cutting blade 50, and the second cutting blade 60 together.

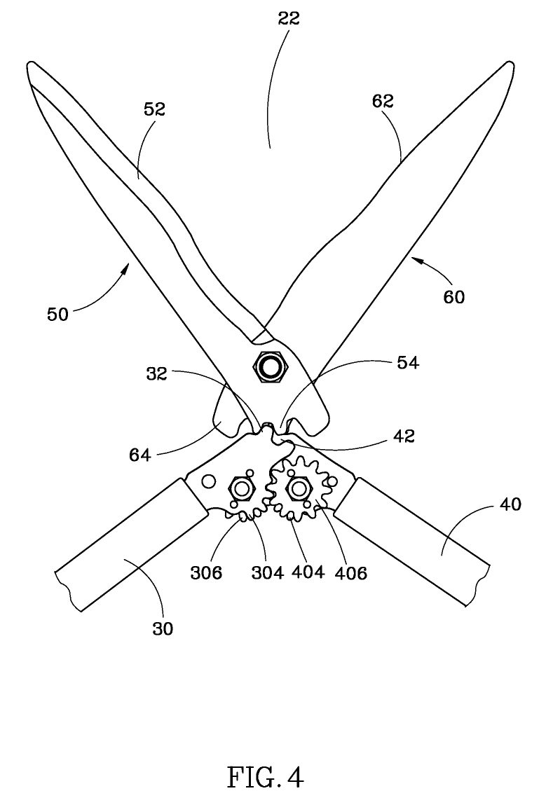

When using the gardening shears 20, a user can force the first handle 30 and the second handle 40 to move away from each other through the engagement of the first lateral teeth 304 of the first handle 30 and the second gear 406 of the second handle 40 and the engagement of the first gear 306 of the first handle 30 and the second lateral teeth 404 of the second handle 40, so as to drive the first cutting blade 50 and the second cutting blade 60 to move away from each other through the engagement of the first teeth portion 32 of the first handle 30 and the fifth teeth portion 54 of the first cutting blade 50 and the engagement of the third teeth portion 42 of the second handle 40 and the sixth teeth portion 64 of the second cutting blade 60, allowing a cutting mouth 22 defined between the first cutting edge 52 and the second cutting edge 62 to be opened, as shown in FIG. 4. Thereafter, the user can place a to-be-cut branch in the cutting mouth 22 and force the first handle 30 and the second handle 40 to move toward each other for driving the first cutting edge 52 of the first cutting blade 50 and the second cutting edge 62 of the second cutting blade 60 to cut the branch placed in the cutting mouth 22 by means of the engagement of the first teeth portion 32 of the first handle 30 and the fifth teeth portion 54 of the first cutting blade 50 and the engagement of the third teeth portion 42 of the second handle 40 and the sixth teeth portion 64 of the second cutting blade 60.

In comparison with the conventional gardening shears that are constructed with a single pivot, the gardening shears of the present invention are worked by the engagement of teeth such that the area of the cutting mouth of the gardening shears of the present invention can be greater than that of the conventional gardening shears, and consequently the gardening shears of the present invention can be applied to cut a branch with a large cross-sectional area, thereby providing the advantage of convenient operation.

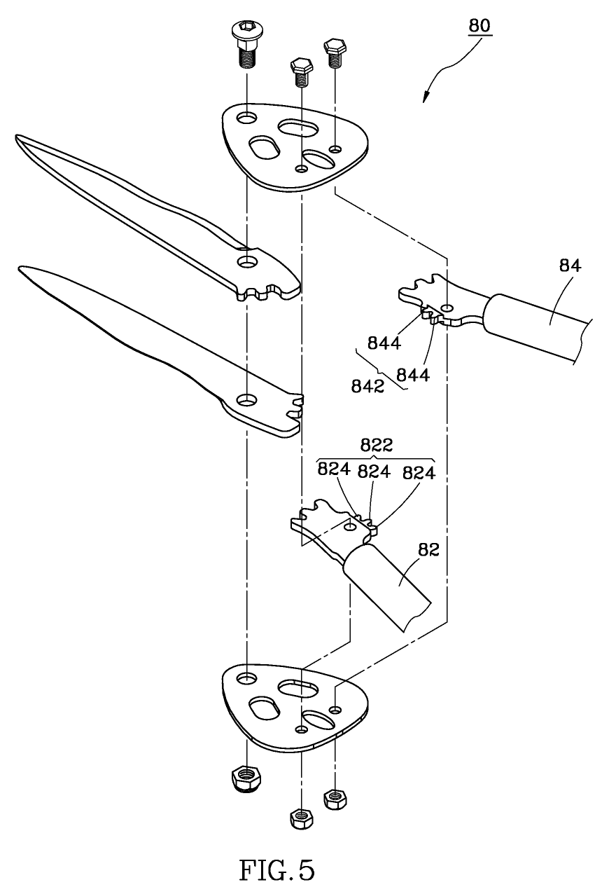

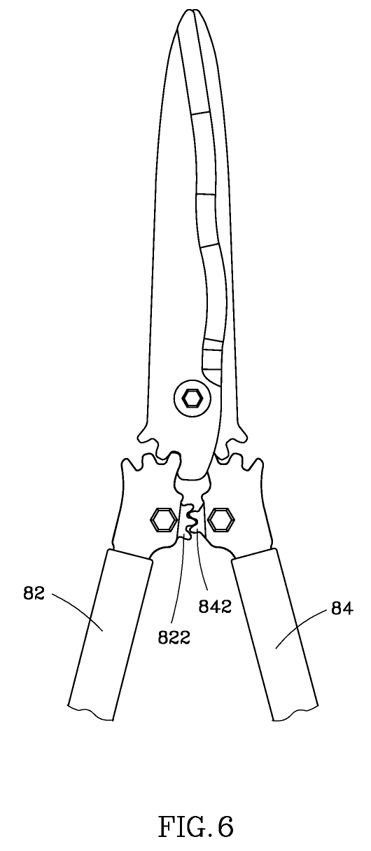

FIG. 5 shows a pair of gardening shears 80 according to a second preferred embodiment of the present invention. In this embodiment, the second teeth portion 822 of the first handle 82 is formed with a plurality of first lateral teeth 824 that are integrally formed at the first handle 82, and the forth teeth portion 842 of the second handle 84 is formed with a plurality of second lateral teeth 844. Further, the second teeth portion 822 and the forth teeth portion 842 are respectively dented downwards and upwards by means of a stamping action, such that they are flush for engagement with each other, as shown in FIG. 6.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A pair of gardening shears comprising:
a first handle having a first teeth portion and a second teeth portion;
a second handle having a third teeth portion and a forth teeth portion engaged with the second teeth portion of the first handle;
a first cutting blade connected to the first handle and the second handle, and having a fifth teeth portion engaged with the first teeth portion of the first handle; and
a second cutting blade pivotally connected to the first cutting blade and connected to the first handle and the second handle, the second cutting blade having a sixth teeth portion engaged with the third teeth portion of the second handle.

2. The gardening shears as claimed in claim 1, wherein the first teeth portion is integrally formed at the first handle, and the third teeth portion is integrally formed at the second handle.

3. The gardening shears as claimed in claim 1, wherein the second teeth portion is integrally formed at the first handle, and the forth teeth portion is integrally formed at the second handle.

4. The gardening shears as claimed in claim 1, wherein the fifth teeth portion is integrally formed at the first cutting blade, and the sixth teeth portion is integrally formed at the second cutting blade.

5. The gardening shears as claimed in claim 1, wherein the first handle has a plurality of first lateral teeth and a first gear, and the second handle has a plurality of second lateral teeth engaged with the first gear and a second gear engaged with the first lateral teeth; the second teeth portion of the first handle is formed of the first lateral teeth and teeth of the first gear, and the forth teeth portion of the second handle is formed of the second lateral teeth and teeth of the second gear.

6. The gardening shears as claimed in claim 1, further comprising a pair of protecting covers, each of which has a top pivotally connected to the first cutting blade and the second cutting blade, and a bottom fastened to the first handle and the second handle.
